(19) United States
(12) Patent Application Publication
(10) Pub. No.: US 2010/0293181 A1
(43) Pub. Date: Nov. 18, 2010

(54) VALUEpilot - METHOD AND APPARATUS FOR ESTIMATING A VALUE OF A VEHICLE

(75) Inventors: Kai Muller, Ratingen (DE); Jochen Kohlmann, Villingen-Schwenningen (DE)

Correspondence Address: RATNERPRESTIA, P.O. BOX 980, VALLEY FORGE, PA, 19482, US

(73) Assignee: AUTOonline GmbH Informationssysteme, Neuss (DE)

(21) Appl. No.: 12/467,574

(22) Filed: May 18, 2009

(51) Int. Cl. G06F 17/30

(52) U.S. Cl. 707/759; 707/776; 707/803; 707/955; 707/609; 707/805; 707/954; 707/708

(57) ABSTRACT

The present invention relates to a method for generating an estimated value of a car, comprising the steps of receiving a user query specifying at least the type of a car; providing a database which comprises datasets having a car specification dataset specifying at least the type of the car and a car value field assigned to the respective car specification dataset representing the reference value of the car specified in the car specification dataset; searching in the database to find one or more datasets matching the user query; and calculating the estimated value of the car using the car value fields of the found datasets.

### FIELD OF THE INVENTION

The present invention relates to a method and to an apparatus for estimating a value of a pre-owned vehicle. In particular, the invention relates to a method for generating a database specifying values of pre-owned vehicles and to a method for generating an estimated value of a pre-owned vehicle.

Further, the invention relates to a system for generating an estimated value of a pre-owned vehicle and to a system for maintaining a database.

### BACKGROUND OF THE INVENTION

Estimating the value of a vehicle is a fundamental issue in merchandising pre-owned vehicles including crash vehicles. Dealers involved with such business need reliable information on the value of the cars they are merchandising. The closeness of the information to the market is important for the business success of the dealer. If the information on the vehicle value is not close enough to the market, the dealer takes the risk to pay an excessive price when purchasing and consequently to ask for an exaggerated price when trying to sell the vehicle. So, miscalculating the price may result in poor business such as profit decrease or even loss of money.

Currently, service providers such as the EurotaxSchwacke GmbH in Germany and the National Automobile Dealers Association (NADA) in USA have focused on sourcing market-reflective price information on second hand vehicles. The editorial teams of these companies collect and analyze large amounts of auto-related transactions per month, including both wholesale and retail sales. NADA derives the data from used car dealers and auctions. EurotaxSchwacke derives the data from bid-prices from rental car companies, bid- and ask-prices from used car dealers, individual dealer surveys, telephonic dealer questionnaires, as well as statistical data on new registrations, changes of ownership and inventory figures.

The customer may generally access the price information over the internet by entering a database query. The characteristic parameters of the vehicle determining the query comprise information such as year and month of vehicle registration, make, type, fuel, doors, mileage. Additionally, the customer may specify the desired optional equipment, such as sunroof, cruise control, anti-lock breaking system, etc.

After submitting the query, the customer obtains the desired price information on the previously configured vehicle.

### SUMMARY OF THE INVENTION

It is an object of the invention to improve the existent techniques for evaluating pre-owned or accident damaged vehicles.

According to an aspect of the invention, a method for generating an estimated value of a car which commonly is a pre-owned vehicle is suggested. The estimated car value corresponds to the car replacement value. The vehicle is either a passenger car or a truck or a bus or a special-purpose vehicle or any other vehicle usually obtainable in the vehicle market. The method comprises the steps of receiving a user query, providing a database, searching in the database and calculating the estimated value. The database comprises on one hand data related to the definition or specification of the cars such as datasets having a car specification dataset specifying at least the type of the car, and on the other hand a car value field assigned to the respective car specification dataset representing the reference car value specified in the car specification dataset. It is noted that the reference car value or any other value may also be a range of values having an upper limit value and a lower limit value.

In an embodiment, the reference car value can be the value of a reference car with basic equipment, i.e. for example a stripped car bare of any supplementary features such as sunroof or ABS. Supplementary features are parts of the equipment that do not belong to the basic equipment of the reference car.

The objective of the user query is to specify the information necessary to identify a specific car comprising at least the type of the car. Based on the user query, searching in the database can be performed to find one or more datasets matching the user query. For each obtained car, the estimated reference value is calculated using the car value fields of the found datasets. The query may provide one or more similar cars. The query may also provide no results, for example if the specified car is not highly popular and as a result no dataset about that car is available in the database.

In an embodiment, a query providing several cars, wherein all cars match the same car specification, can be used to optionally assign a representative car value to that car specification. Accordingly, the representative car value can be calculated from the found reference car values according to a mathematical formula, for example an average or a weighted average of the single reference car values. The representative car value can be associated with a relevance figure defining the degree of confidence accordable to the representative car value. For example, ten traded cars with a certain specification accord the achieved representative value a higher degree of confidence than only two traded cars.

Thus, the relevance figure is functionally dependent on the number of traded cars. Besides that, the representative car value can be associated with a confidence range, derived from the single reference car values, e.g. from the upper and lower limit of the single reference car values, having an upper limit value and a lower limit value.

According to another aspect of the invention, a method for generating and maintaining a database is suggested. An input obtained from car valuation systems is received. Subsequently, the input is divided into several categories such as a car specification dataset, a car value field representing the car market value and supplementary data specifying the supplementary car features. After that, predefined values specifying the value of supplementary features of the car in the dataset are obtained.

Finally, the reference value of the car is calculated, and the car specification dataset is stored together with the calculated reference value of the car in the database.

The initially received input can originate form from valuation systems, preferably car survey reports or car auctions. Compared with standard evaluating methods based on questioning bid and ask prices of used car dealers, prices obtained from auctions have the advantage of being real prices thus reflecting the market. The marketability of prices obtained from survey reports is as well excellent, such prices reflecting the level practiced by insurance companies. The input is received preferably either via internet or via dedicated data line or via shipment of storage devices such as CD-ROM's.

A car specification dataset specifies at least the type of car as well as other characteristics such as make, age, etc. A car value field assigned to the respective car specification dataset represents the market value of the car. The market value is the value of a market car as it has been transacted including its specific supplementary features. Supplementary data specifies supplementary features such as GPS navigation or power sunroof. Preferably, a reference car is understood as having a basic equipment. Supplementary features, such as GPS navigation, power sunroof, air condition or park distance control, are, according to an embodiment, not included in the basic equipment.

The step of obtaining values specifying the value of supplementary features is executed in order to obtain values reflecting purchase prices of the supplementary features. These values, which are preferably predefined, may be introduced into the database from external sources, such as distributors of car equipment, data vendors or traders of second hand car equipment. Depending on the age of the considered car, the actual market value of supplementary features may be obtained by mathematically adjusting the original value to regard the time dependent value decrease. In contrast, the prices obtained from traders of second hand car equipment are actual time values.

The step of calculating the reference value of the car specified in the database refers to a reference car with basic configuration. According to an embodiment, the calculation includes the process of stripping the supplementary features from the equipment of the market car, the supplementary features being included in the supplementary features part of the dataset. Calculating the value of a reference car preferably includes subtracting the value of the supplementary features of the dataset from the market value of the car of the dataset as it has been obtained from car valuation systems.

The step of storing the car specification dataset together with the calculated reference value of the car in the database makes sure that these values are subsequently available for any user query.

According to a further aspect of the invention, a system for generating an estimated value of a car comprising a database for storing datasets, and a car value estimating program is suggested. The database comprises at least a car specification dataset specifying at least the type of the car and a car value field assigned to the respective car specification dataset representing the reference value of the car. The car value estimating program is configured to receive a user query, to search in the database for one or more datasets matching the user query and to calculate an estimated value of the car using the car value fields of the matching datasets.

According to another aspect of the invention, a system for maintaining a database comprising a database for storing datasets and a database maintenance program is suggested. The database comprises at least a car specification dataset specifying at least the type of the car, a car value field assigned to the respective car specification dataset representing the market value of the car, and supplementary data specifying the supplementary features of the car. The database maintenance program is configured to receive an input obtained from valuation systems, preferably car survey reports or car auctions, to obtain predefined values specifying the value of supplementary features of a car in the dataset, to calculate the reference value of the car specified in the dataset by subtracting the value of the supplementary features of the dataset from the market value of the car of the dataset, and to store the car specification dataset together with the calculated reference value of the car in the database.

In a preferred embodiment, storing the supplementary data specifying the supplementary features and the values of supplementary features in the database is performed. The availability of supplementary features data in the database allows to calculate the car reference value from the car market value and vice versa to virtually equip a reference car with any supplementary features and to evaluate this car.

Preferably, the car specification dataset comprises at least one of the fields of make or brand (e.g. Chrysler, GM, Toyota), model (e.g. Crossfire, Corvette, Prius), age (e.g. three years), vehicle type or body style (e.g. SUV, sport, convertible), fuel (e.g. benzine, diesel), displacement (e.g. 2.8 liter), odometer (e.g. 50,000 km, 40,000 miles), engine power (e.g. 280 hp), and geographical area (e.g. US/New York, US/Montana, CN/Vancouver). The list is open-ended and may comprise all fields necessary for a clear and unambiguous specification of the specific car.

In a specific embodiment, calculating the estimated car value comprises the processes of obtaining a dataset of a car after performing the step of searching. Subsequently, entering the dataset at an input data interface of a mapping model and evaluating the estimated value of the car at an output data interface of the mapping model is performed. The mapping model may implement a mathematical relation between the input data and the output data such that the reference car value functionally depends on the car specification dataset.

Preferably, the step of calculating the estimated value comprises adding one or more values specifying the value of supplementary features related to the user query to the estimated reference value. This way, the already mentioned evaluation of a virtual used car equipped with any supplementary features starting from a reference car available in the database is possible.

In a specific embodiment, the predefined values specifying the value of supplementary features can be determined from the average values of supplementary features. This calculation is useful in cases when several price values are assigned to one specified set of supplementary features, which may occur if the supplementary features data is obtained from second hand car dealers or from vendors of second hand cars data.

Preferably, the supplementary features comprise at least one of air condition, park distance control, ABS and all-wheel drive. The list is open-ended and may comprise all items currently available for the specified car, either new or second hand.

Preferably, the step of searching involved in generating an estimated car value comprises a context-sensitive full-text search. The search items, which have to be part of the car specification dataset, can be entered arbitrarily ordered into a text field. In most cases, one text field is enough but, if necessary, several text fields can also be employed. The search engine performs a mapping from the entered search items to the car specification dataset. The user interface is similar to that of internet search applications such as google.com or yahoo.com. Keeping in mind the high degree of familiarity of most users with the internet, the way of searching according to the invention is extremely intuitive, fast and simple.

In a specific embodiment, the step of searching comprises a fast search mode which consists in entering a standardised string value pointing to the car specification dataset into the data base. Such a string value may comprise the manufacturer number and the type key number. The string value may be a compressed character expression comprising in short-form the items of the car specification dataset. Using such a string is helpful for users familiar with the names and identifiers commonly in use in the car business.

Preferably, searching comprises an iterative refinement of the car specification dataset. If the car specification dataset obtained from the search items entered by the user is ambiguous, the user interface may respond by asking the user for the missing items. The user interface may offer a list comprising the cars matching the search items, wherein the user clicks the desired item to narrow down the search result. When asking for these items, the user interface may offer intuitive help and assistance to facilitate and accelerate the handling. The help may consist in displaying information and explanations on the required items as well as context sensitive item lists.

In a specific embodiment, the car which has to be evaluated can be an accident damaged car. In this case, the dataset comprises repair data referring to spares data and spares values related to the car as well as labor data and labor value related to repairing the damaged car. The value of the accident damaged car can be estimated by subtracting from the car reference value the spares value and the labor value necessary for reparation. If the damaged car is equipped with supplementary features which are not damaged, then the current value of the supplementary features which are not damaged is subsequently added. The estimated value is the residual value of the car commonly employed by insurance companies in case of an accident.

In an embodiment, the user query involved in generating an estimated car value may refer to a car specification dataset that is not comprised in the database, for example if the specified car is not highly popular and as a result no dataset about that car is available. Such a case is determined by detecting a car which is to be evaluated whose car specification dataset is not included in the database. If the user still wants to obtain a car value corresponding to that dataset, for example because he intends to buy such a car, then calculating a virtual value of the car from datasets of similar cars can be performed. In such cases the mapping model is responsible to perform an adequate operation. The mapping model performs an interpolation for example if datasets are available specifying a 3 years, a 4 years and a 6 years old car, but the query refers to a 5 years old car whose remaining parameters in the car specification dataset are identical with that of the cars found in the database, except the age of the car. The mapping model performs an extrapolation for example if datasets are available specifying a car with a 2.8 liter, 3.2 liter, and 3.7 liter engine, but the query refers to a car with a 4.5 liter engine, whose remaining parameters in the car specification dataset are identical with that of the cars found in the database, except the displacement. This principle is applicable to other parameters too, e.g. odometer or engine power. In other cases, the mapping model can perform linear or non-linear regression.

Preferably, the database maintenance can be performed with data from car auctions which are public or non public or a combination thereof. Public auctions are processed such that the auction arranger invites all the interested buyers and sellers. With non-public auctions, the invitation for the auction is of a strictly personal or even confidential nature, and none else may participate in such an auction. As far as the type of offering is concerned, the auctions are traditional, whereby the auctoneer and the buyers are physically present at the place of the auction, or online auctions, wherein the potential buyers place their bids electronically for example via internet or via any computer network. The auctions are preferably direct auctions, but inverse auctions are also within the scope of the invention.

In a specific embodiment, the database maintenance can be performed with the data of an accident damaged car. For evaluating such a car it is necessary to have exact information on the damage including which parts are damaged, which parts have to be exchanged or repaired and the amount of labor necessary for both exchanging and repairing the parts.

Preferably, when performing database maintenance with the data of an accident damaged car, the step of obtaining repair data specifying spares data, spares values, labor data, labor values is performed. The common sources of repair data can be car survey reports, car auctions, data vendors or spared data dealers. Above step is followed by storing the repair data in the database. The obtained data may contribute to the enlargement of the data stock and is available for subsequent user queries and database searches.

Preferably, when performing database maintenance with the data of an accident damaged car, calculating the car reference value can be performed by adding to the value of the accident damaged car the spares value and the labor value. Subsequently, the value of the supplementary features of the dataset which are not damaged can be subtracted. Generating car reference values from accident damaged cars may enlarge considerably the amount of data stock in the database. Preferably, the database can be a relational database or a fuzzy database, including fuzzy string searching related to approximate or inexact matching.

Preferably, the mapping model establishing a mapping of the car specification dataset on the car value to be estimated is determined. The mapping model comprises an input data interface, an output data interface and a set of adaptive model parameters. Input data, such as a car specification dataset can be entered at the input data interface. Output data, such as the stripped market value or the reference value of a car can be either entered or can be obtained at the output data interface. The mapping model implements a mathematical relation between the car specification dataset and the estimated car value such that the reference car value functionally depends on the car specification dataset. For example, if a specific car has been merchandised a number of times, a number of market values are assigned to one car specification dataset. For assigning exactly one estimated car value to that car specification dataset, the estimation may be obtained by averaging the market values. If additional items, e.g. characteristics of the buyer such as sex, solvency and age, have to be taken into account, it is also possible to calculate a weighted average of the market values, wherein the weights are represented by mentioned additional items. In these examples, the mapping model calculates an output data by applying an operation of averaging or weighted averaging to the input data. It is in the scope of the invention that the mapping model may implement any kind of mapping operation to the input data including a statistical operation or an operation related to artificial intelligence methods such as fuzzy data or artificial neural networks.

Preferably, determining the mapping model can be performed by adapting the model parameters to obtain an optimized matching between the car specification dataset entered at the input data interface and the reference car value entered at the output data interface. Adapting the model parameters can be done for example by an optimization process wherein the process subsequently modifies the model parameters with the scope of obtaining a minimum difference between the predetermined market value of a specified car and the estimated value of that car which had been obtained with the model on basis of the car specification dataset or, more general, on basis of the input data.

Preferably, the mapping model comprises a fuzzy data network or a neural network or a hybrid fuzzy-neural network or any statistical model whose parameters are adaptable. With a fuzzy data network, the evaluation result can be an interval of values.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 illustrates a process of generating an estimated value of a car according to a first embodiment of the present invention;

FIG. 2 illustrates the process of generating and maintaining a database according to a second embodiment of the present invention;

FIG. 3 illustrates a chart showing a depreciation analysis of a car according to a third embodiment of the present invention;

FIG. 4 illustrates the process of generating an estimated value of a car according to a fourth embodiment of the present invention;

FIG. 5 illustrates a first aspect of a user interface; and

FIG. 6 illustrates a second aspect of a user interface.

### DETAILED DESCRIPTION OF THE PREFERRED EMBODIMENTS

Reference will now be made in detail to the exemplary embodiments of the invention illustrated in the accompanying drawings.

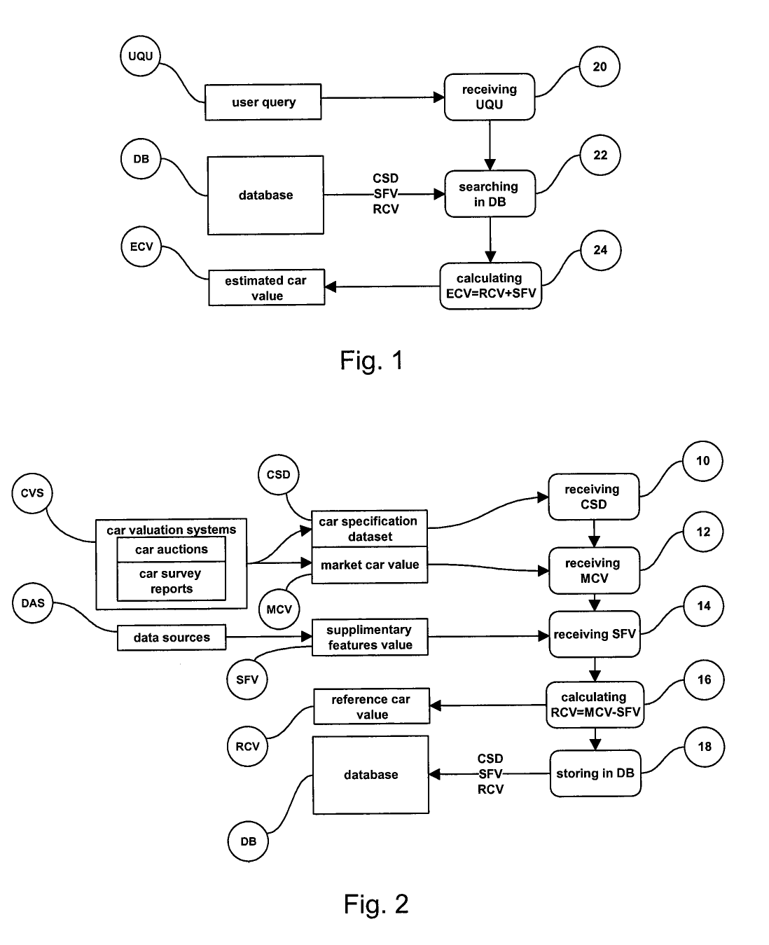

In the embodiments illustrated in FIGS. 1 and 2, the invention relates to the main processes of responding to a user action and of maintaining a database DB for the storage of datasets. Each dataset comprises a car specification dataset CSD, a car value field assigned to the respective car specification dataset CSD representing the reference car value RCV, supplementary data specifying the supplementary car features including supplementary features value SFV and the estimated car value ECV.

Responding to a user action with the scope of evaluating a pre-owned car as shown in FIG. 1 comprises receiving in step 20 the user query UQU. The user performs such a query with a context-sensitive full-text search tool. An adequate graphical user interface offers several text fields for entering the search items comprising the car specification dataset CSD, the supplementary features as well as own comments related to the query and other search items. The query and the related items may be stored and easily re-utilized by the user.

Searching in step 22 in the database DB for one or more datasets matching the user query UQU is performed on the basis of the search items. Depending on the degree of completeness of information in either the user query or the database or both, the user receives either one result when the car specification dataset is e.g. duly completed and matches a single car specification dataset or otherwise several results. For example, if the user fails to specify one of the parameters of the car specification dataset, e.g. the engine power, the query is going to supply a multitude of results, each result referring to the chosen car specification dataset, differing only in the engine power from the other results.

On the other hand, each result may comprise one or more cars, depending on the number of transacted cars stored in the database matching the car specification of the user query. For example, if a five years old Chrysler Crossfire, with a four liter benzine engine has been traded ten times in the New York region, the result comprises ten cars.

Alternatively, a result comprising several cars may be expressed with only one value corresponding to a representative car value. The representative car value is associated with additional figures such as a relevance figure, defining the degree of confidence accordable to the representative car value, and a confidence range, defining the highest and lowest estimated car values ECV. The larger the number of found cars, the higher the relevance figure. The confidence range depends on the highest and lowest car reference values CRV and on the supplementary feature values SFV of these cars.

If a special car has not been at all transacted at the considered car auctions, then no dataset about that car is available. In this case, the query provides zero results, i.e. it does not provide any car.

Finally, calculating the estimated car value ECV by adding the supplementary features value SFV of the dataset to the reference car value RCV of the dataset corresponding to the formula

ECV=RCV+SFV (1)

is performed.

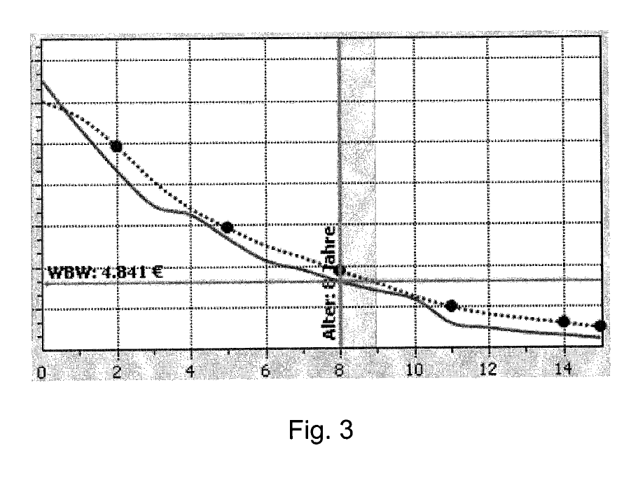

With a single query, the calculation process can be performed once, if the value of a single car is desired, or multiply, if a series or an analysis is desired. An analysis comprises calculating a car history and displaying the result in form of a chart as shown in FIG. 3. The car history refers to the replacement values of a car with specified characteristic data. Usually, when a data series, such as the car history of a specific combination of make and type is needed, the age of the car is not fixed thus obtaining all values available in the database DB for the desired combination without regard of the age. After calculating the car values, an ordering by the age is performed to graphically display the data.

Based on the capability of calculating data series, diverse analyses can be performed. For example, analyzing the dependency of car values on diverse parameters is possible, such as age, displacement, odometer (mileage) or engine power. The result of such an analysis comprises a series of values depending on the chosen parameter. If for example an analysis needing the age history of a car is desired, the result comprises a time series showing the time dependency of the car values.

The result of an analysis is displayed using 2D charts. For example, with an analysis concerning the time dependency of car replacement value, a chart showing a value corridor or value range is shown, since the result corresponding to each car age comprises a multitude of values originating from different estimated reference values ERV or marked car values MCV. Such a multitude originate in a multitude of auctions wherein similar cars are traded, for example cars with same make, type, fuel, displacement, odometer, etc.

The correlation between a curve calculated from a mathematical time dependency and a curve calculated conforming to the invention gives the user useful information concerning the time dependency of the depreciation of a specific car. FIG. 3 shows two depreciation curves for a car with a specified make and type. One of the curves is calculated with a mathematical formula representing a 2% per month depreciation of the car replacement value. The other curve is calculated conforming to the invention. Form this chart the user gets an overview over the history and the possible future development of a specified car, thus facilitating the user decision of buying or selling that car.

Buyers generally are interested in future price development mainly for evaluating the risk associated with their investment. Thus, a special focus is directed on calculating forecast values from statistical data obtained from risk consulting companies.

With a database search corresponding to FIG. 1, calculating the estimated car value ECV is performed by accessing the stored reference car value RCV and the specific supplementary features value SFV. Thus, it is possible to generate virtual cars with a much larger diversity of equipments including diverse combinations of supplementary features compared with an analysis taking into consideration only market cars with fixed equipment as traded in the car market.

Maintaining the database as shown in FIG. 2 is another basic aspect of the invention. This process comprises receiving in step 10 the car specification dataset CSD and receiving in step 12 the market car value MCV from valuation systems CVS, followed by receiving in step 14 the supplementary features value SFV from data sources DAS. Such data sources are, as far as new components are concerned, car manufacturers, dealers of new cars, car survey reports, repair and assembling shops, wholesale dealers and third party data vendors. As far as used components are concerned, data sources may be dealers of second hand cars and car auctions. Subsequently, calculating in step 16 the reference car value RCV specified in the dataset by subtracting the value of the supplementary features SFV of the dataset from the market value of the car MCV of the dataset corresponding to the formula

RCV=MCV−SFV (2)

is performed.

The market car value MCV in equation (2) corresponds to a car having a certain car specification. This car has been traded in the car market and the corresponding car data has been obtained for example from a car auction. Equation (2) can be re-written, thus obtaining the market car value (MCV):

MCV=RCV+SFV (2′)

The market car value MCV in equation (2′) has the same car specification as the car conforming to equation (1). Consequently, the estimated car value ECV in equation (1) equals to the market car value MCV in equation (2′). The only difference is that the estimated car value ECV has been calculated (estimated), whereas the market car value MCV has been obtained from a real trade in the car market.

Finally, storing in step 18 the car specification dataset CSD together with the calculated reference car value RCV in the database DB is performed.

From FIG. 2 it is evident that calculating the reference car value RCV is performed immediately after receiving the input data, i.e. the car specification dataset CSD, the market car value MCV and the supplementary features value SFV. Subsequently, the reference car value RCV is stored in the database DB, without storing the market car value. Thus, computing efficiency is increased and considerably less storage place is needed compared with storing every market car value MCV including the corresponding supplementary features and the supplementary features value SFV.

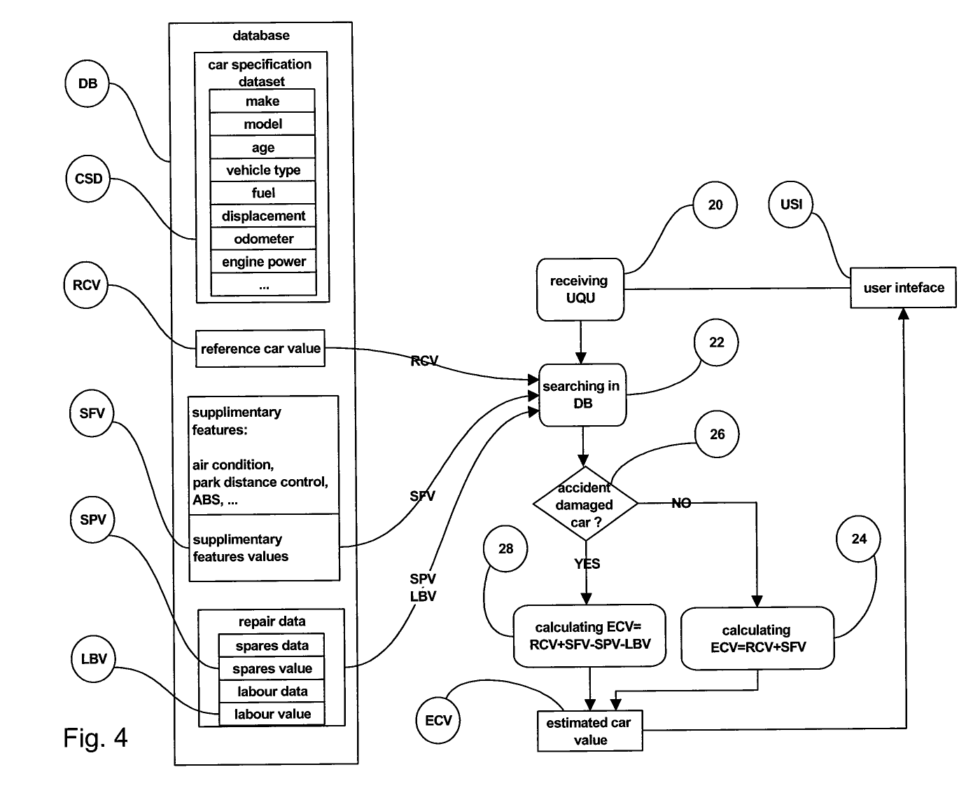

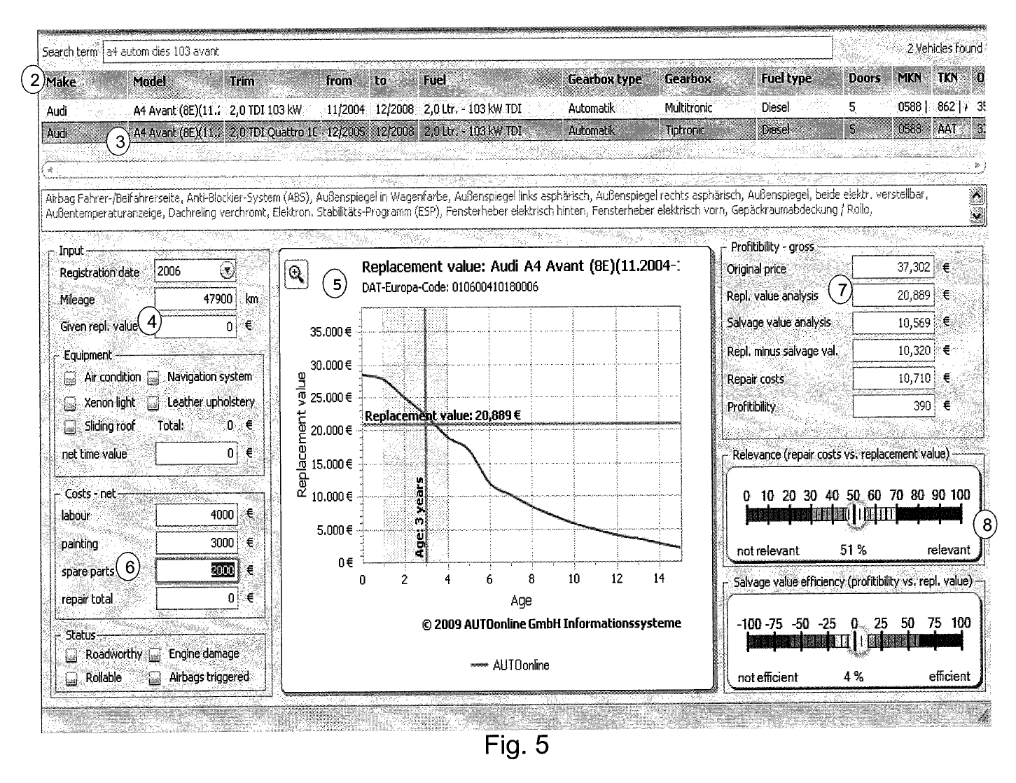

FIG. 4 shows the process of responding to a user action in a more complex case when the car is either an accident damaged car or an intact second hand car. The first step is receiving in step 20 the user query UQU from an user interface USI. The user interface USI can be either a keyboard and display combination of a neighboring computer or of any other computer attached to the internet.

Second step is searching in step 22 in the database DB for one or more datasets matching the user query UQU. The search may access in step 26 to a regular second hand car or to an accident damaged car. In both cases, the user may wish to evaluate an existing car with a specific configuration driven by the intention to buy or to sell that car.

If the existing car is non-damaged, calculating the estimated car value ECV is performed by adding the value of the supplementary features SFV of the dataset to the reference car value RCV of the dataset corresponding to the formula (1).

If the existing car is accident damaged, then calculating the estimated car value ECV additionally involves subtracting the spares value SPV and the labor value LBV associated with repairing that car. The calculation corresponds to the formula

ECV=RCV+SFV−SPV−LBV (3)

FIG. 5 shows a first aspect of the graphical user interface of an application which implements a system for generating an estimated value of a car. Therein, a couple of key-facts are apparent:

1. Very fast and ergonomic identification of a car with just a few information,

2. Estimation of the Replacement Value (ACV) of the car,

3. Forecast of the Residual Value (Salvage) of the car.

With this information insurances/adjusters are immediately able to decide how to handle a case.

Some of the used technologies are:
Google-like search in the reference database, e.g. DAT (Deutsche Automobil Treuhand),
Prognosis according to Prof. Weyer (Risk Consulting) multivariate regression methods,
Additional assessment on neural network basis (artificial intelligence),
Validation through PSO (Particle Swarm Optimization),
More than 2 million historical records (ACVs etc.) from the production database.

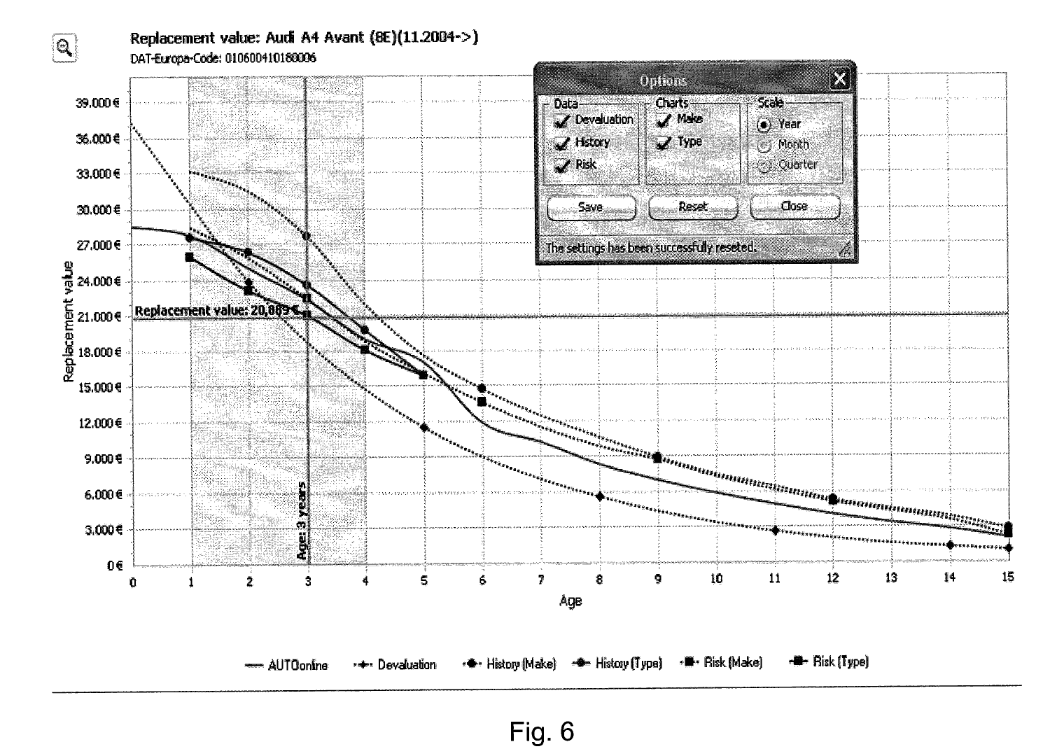

After installation of the application, the user has to start the application and login. The application will verify the account information online once and grant access to the user for a defined period of time (Expiration Date), e.g. three weeks.
(2) Enter the known facts about the car, e.g.: make, power, doors. No special order nor complete words are necessary.
(3) Choose the proper car (any additional information entered in SEARCH TERM will shrink the list).
(4) Select the correct registration date (average mileage for this type is shown, but one can adjust if needed). Enter some influential equipment.
(5) Graphic with the devaluation curve. The ACV is highlighted.
(6) Add costs of PAINTING, LABOR, SPARE PARTS if forecasting the salvage value is desired.
(7) In this frame the original price of the standard car can be found, the estimated ACV and the forecast of the salvage value. Repair costs and compensation costs (profitability) can now be compared with one another.
(8) Relation between repair and ACV is shown. In FIG. 6 is shown the efficiency (to use the residual value calculation according to the invention or not).

The devaluation curve results from the combination of:
the selling price devaluation,
the average ACV history for chosen make,
the average ACV history for chosen model,
the mathematical models form RISK Consulting,
the Al algorithms from KNN.

Some of the benefits of the system for generating an estimated value of a car are:
Very fast and ergonomic identification of a car with just a few information,
Estimation of the Replacement Value (ACV) of the car,
Forecast of the Residual Value (Salvage) of the car.

The processing steps towards the insurance company are:
1. The insurance company sends claims to the system operator through an automatic process,
2. The system operator does Optical/Intelligent Character Recognition,
3. Historical data combined with mathematical intelligence helps to decide the best way to process claims,
4. The system operator sends immediate action recommendation to the insurance company,
5. The system operator sends the insurance company the bid page with a guaranteed salvage value after the end of the auction.

To assure forecast quality and reliable results, a couple different methods are combined:
Google-like search in reference database to identify vehicles and find the original prices,
Prognosis according to multivariate regression methods (Mathematical Faculty, Cologne University),
Additional assessment on neural network basis (Artificial Intelligence),
Validation through Particle Swarm Optimization (PSO),
Data Mining Algorithms, more than 4 million historical records used from the production database.

The requirements to set up the system for generating an estimated value of a car are as follows:
Roll out of the system in foreign markets: The insurance company has to provide as many archived records as possible with Salvages and Replacement Values.
Records should contain: Vehicle type, brand, Model, type of engine and gear, chassis, first registration date, mileage, doors, cylinder capacity, power, color, equipment, labour costs, costs of spare parts, painting, repair, salvage attained, replacement value.
Technical integration:
   Set up or integrate a referenced database (DAT, JATO) with all available car types on the market for clustering car segments,
   Research macroeconomic trends and influences to value development,
   Find correlations and dependencies between different markets to compute forecast with limited market data,
   The system supports all common transfer protocols and data formats.

The steps for the accommodation of a new customer are as follows:
Send the operator the customer's archived assessment records,
Build up an Interface to send the operator the customer's current assessment records,
Publishing of all vehicles online,
Review Meeting and individual adaptation to local needs.

1. A method for generating an estimated value of a car, comprising the steps of:
a) receiving a user query specifying at least the type of a car;
b) providing a database which comprises datasets having a car specification dataset specifying at least the type of the car and a car value field assigned to the respective car specification dataset representing the reference value of the car specified in the car specification dataset;
c) searching in the database to find one or more datasets matching the user query; and
d) calculating the estimated value of the car using the car value fields of the found datasets.

2. A method for generating an estimated value of a car according to claim 1, wherein the car specification dataset comprises at least one of the fields of make, model, age, vehicle type, fuel, displacement, odometer, engine power, and geo-graphical area.

3. A method for generating an estimated value of a car according to claim 1, wherein step d) of calculating comprises the following steps:
d1) obtaining a dataset of a car after performing the step of searching;
d2) entering the dataset at an input data interface of a mapping model;
d3) evaluating the estimated value of the car at an output data interface of the mapping model.

4. A method for generating an estimated value of a car according to claim 1, wherein the step of calculating comprises the calculation of an average value or weighted average value of the car value fields of the cars of the found datasets.

5. A method for generating an estimated value of a car according to claim 1, wherein the step of calculation comprises adding one or more predefined values specifying the value of supplementary features related to the user query to the estimated reference value.

6. A method for generating an estimated value of a car according to claim 5, wherein the predefined values specifying the value of supplementary features are determined from the average values of supplementary features.

7. A method for generating an estimated value of a car according claim 6, wherein the supplementary features comprise at least one of air condition, park distance control, ABS and all-wheel drive.

8. A method for generating an estimated value of a car according to claim 1, wherein the step of searching comprises a full-text search.

9. A method for generating an estimated value of a car according to claim 1, wherein the step of searching comprises entering into the data base a standardised string value pointing to the car specification dataset.

10. A method for generating an estimated value of a car according to one of the claims 8 or 9, wherein the step of searching comprises an iterative refinement of the car specification dataset.

11. A method for generating an estimated value of a car according to claim 1, wherein the car is an accident damaged car and the dataset comprises spares data and spares values related to the car as well as labor data and labor value related to repairing the damaged car, and wherein after completion of step d) the following step is performed:
e) subtracting from the car reference value the spares value and the labor value and adding one or more predefined values specifying the value of supplementary features related to the user query.

12. A method for generating an estimated value of a car according to claim 1, wherein after completion of step d) the following steps are performed:
f) detecting a car which is to be evaluated whose car specification dataset is not included in the database;
g) calculating a virtual value of the car from datasets of similar cars.

13. A method for generating and maintaining a database, comprising the steps of:
k) receiving an input obtained from valuation systems, preferably car survey reports or car auctions;
l) dividing the input into a car specification dataset specifying the type of car, a car value field assigned to the respective car specification dataset representing the market value of the car and optional supplementary data specifying the supplementary features of the car;
m) obtaining predefined values specifying the value of supplementary features of the car in the dataset;
n) calculating the reference value of the car specified in the dataset by subtracting the value of the supplementary features of the dataset from the market value of the car of the dataset; and
o) storing the car specification dataset together with the calculated reference value of the car in the database.

14. A method for generating and maintaining a database according to claim 13, wherein after completion of step o) storing the following step is performed:
p) storing supplementary data specifying the supplementary features and the values of supplementary features in the database.

15. A method for generating and maintaining a database according to claim 14, wherein the car auctions are public or non public or a combination thereof.

16. A method for generating and maintaining a database according to claim 15, wherein after completion of step p) storing the following steps are performed:
q) obtaining repair data specifying spares data, spares values, labor data, labor values;
r) storing the repair data in the database.

17. A method for generating and maintaining a database according claim 16, wherein the car is an accident damaged car and wherein after completion of step r) the following step is performed:
s) calculating a car reference value by adding to the value of the accident damaged car the spares value and the labor value and by subtracting the value of the supplementary features of the dataset which are not damaged.

18. A method for generating and maintaining a database according to claim 17, wherein the database is a relational database or a fuzzy database.

19. A method for generating and maintaining a database according to claim 18, wherein the following step is performed:
t) determining a mapping model which establishes a mapping of the car specification dataset on the car value to be estimated, wherein the mapping model comprises an input data interface, an output data interface and a set of adaptive model parameters.

20. A method for generating and maintaining a database according to claim 19, wherein determining the mapping model is performed by adapting the model parameters to obtain an optimized matching between the car specification dataset entered at the input data interface and the car value entered at the output data interface.

21. A method for generating and maintaining a database according to claim 20, wherein the mapping model comprises a fuzzy data network or a neural network or a hybrid fuzzy-neural network.

22. System for generating an estimated value of a car comprising:
a database for storing datasets comprising at least:
a car specification dataset specifying at least the type of the car;
a car value field assigned to the respective car specification dataset representing the reference value of the car specified in the car specification dataset;
a car value estimating program being configured to:
receive a user query;
search in the database for one or more datasets matching the user query;
calculate an estimated reference value of the car using the car value fields of the matching datasets.

23. System for maintaining a database comprising:
a database for storing datasets comprising at least:
a car specification dataset specifying at least the type of the car;
a car value field assigned to the respective car specification dataset representing the market value of the car; and
supplementary data specifying the supplementary features of a car;
a database maintenance program being configured to:
receive an input obtained from valuation systems, preferably car survey reports or car auctions;
obtain predefined values specifying the value of supplementary features of the car in the dataset;
calculate the reference value of the car specified in the dataset by subtracting the value of the supplementary features of the dataset from the market value of the car of the dataset; and
store the car specification dataset together with the calculated reference value of the car in the database.
